(19) United States
(12) Patent Application Publication
(10) Pub. No.: US 2008/0277001 A1
(43) Pub. Date: Nov. 13, 2008

(54) Valve

(76) Inventor: Christopher Simon Courtenay Wheaton, Devon (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/817,456

(22) PCT Filed: Feb. 23, 2006
(86) PCT No.: PCT/GB2006/000620

§ 371 Date: Apr. 15, 2008

(30) Foreign Application Priority Data
Mar. 1, 2005 (GB) 0504156.1

(51) Int. Cl. F16K 11/20

(52) U.S. Cl. 137/637

(57) ABSTRACT

A valve for use in a closed transfer system for agricultural chemicals and the like comprising a housing (26) for engagement with a neck of a container and a stem (15) with inlet ports (18) to allow flow of liquid therethrough into the container, there being a spring loaded seal (21) movable between respective open and closed positions where it allows or prevents flow through said inlet ports (18), the seal being movable to its open position by a coupler (100) affixed to the housing, in use, and there being a liquid flushing arrangement (27, 28, 29) for introducing flushing liquid into the container when the seal (21) is in its open position. In an alternative arrangement the coupler is engageable with a slidable part (35) of the housing (30) to compensate for restricted headroom above the container neck.

This invention relates to a valve, particularly, though not exclusively, a valve for use with containers for agricultural chemicals.

Various valves are known for use in closed transfer systems for agricultural chemicals, and one such valve is initially screwed into or onto a neck of the container, with the valve being in a closed position. The valve functions by a coupler or other similar tool engaging with a mating detail at the exterior of the valve. Activation of a lever on the coupler pushes a seal and backing ring down a stem of the valve to expose stem ports and to allow transfer of the chemicals, by means of a pump, vacuum source or other extraction device, into a further container or tank.

Current European Regulations stipulate that any containers which have contained chemicals considered noxious must be triple rinsed before disposal. This presently requires removal of the valve from the container, thereby exposing an operative to concentrated chemical before water can be poured into the container, rinsed around and swilled out. Clearly this procedure is disadvantageous in exposing the operative to such harmful residues inside the container.

An object of the invention is to reduce said disadvantage.

According to the present invention there is provided a valve comprising a housing having a first part for engagement with a neck of a container, a second part defining at least one inlet into the container, when the first part is engaged with the container, in use, spring loaded closure means normally being in a closed position preventing access, in use, to said at least one inlet, the closure means being movable, against said spring loading to an open position to allow such access, by a coupler affixed to said housing, in use, the valve being characterised by a liquid flushing arrangement for introducing flushing liquid into the container, in use, through a non-return valve, said liquid flushing arrangement allowing flushing liquid to flow through said at least one inlet when said closure means is in its open position and preventing flow of flushing liquid when said closure means is in its closed position.

Preferably the liquid flushing arrangement comprises a flushing liquid inlet connection at said first part of the housing.

Desirably the liquid flushing arrangement comprises a spring-loaded plunger which protrudes into the path of movement of the closure means.

Conveniently when the closure means is in its closed position the plunger is engaged by the closure means to retain the plunger in a position where it shuts off liquid flow through the liquid flushing arrangement.

Advantageously when the closure means is in its open position the plunger is in a released position where it allows flushing liquid to flow through the liquid flushing arrangement and to said at least one inlet, into the container, in use.

In said one embodiment or in a further embodiment the liquid flushing arrangement includes sensing means for sensing, in use, the internal pressure in the container.

In another aspect of the invention, the coupler can be affixed, in use, to said housing by way of a mating detail which is retractable relative to the remainder of the housing.

According to a further invention a valve comprises a housing for engagement with a neck of a container and defining at least one inlet into the container, when the first part is engaged with the container, in use, a spring loaded closure means normally in a closed position preventing access, in use, to said at least one inlet, the closure means being movable, against said spring loading to an open position to allow such access, by a coupler affixed to said housing, in use, and mating means for mating with said coupler so that it can be affixed to said housing, said mating means being provided by means which are retractable and extendable relative to said housing.

The invention will now be described, by way of example, with reference to the accompanying drawings, in which:

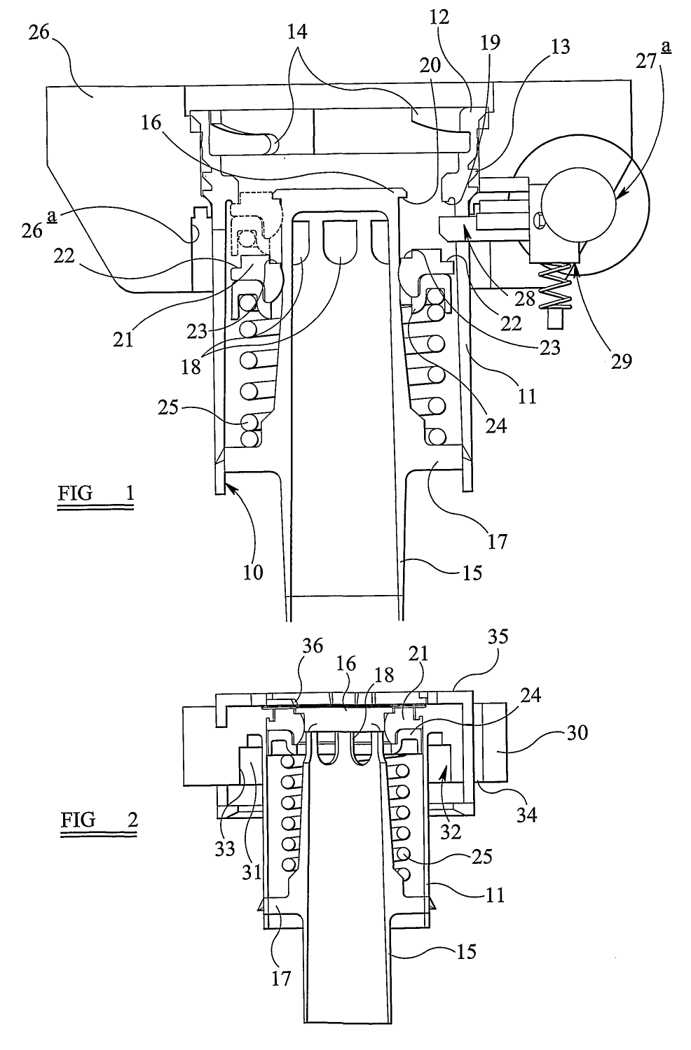

FIG. 1 is a schematic cross-sectional side view of a valve of the invention, shown open in full lines and closed in dashed lines,

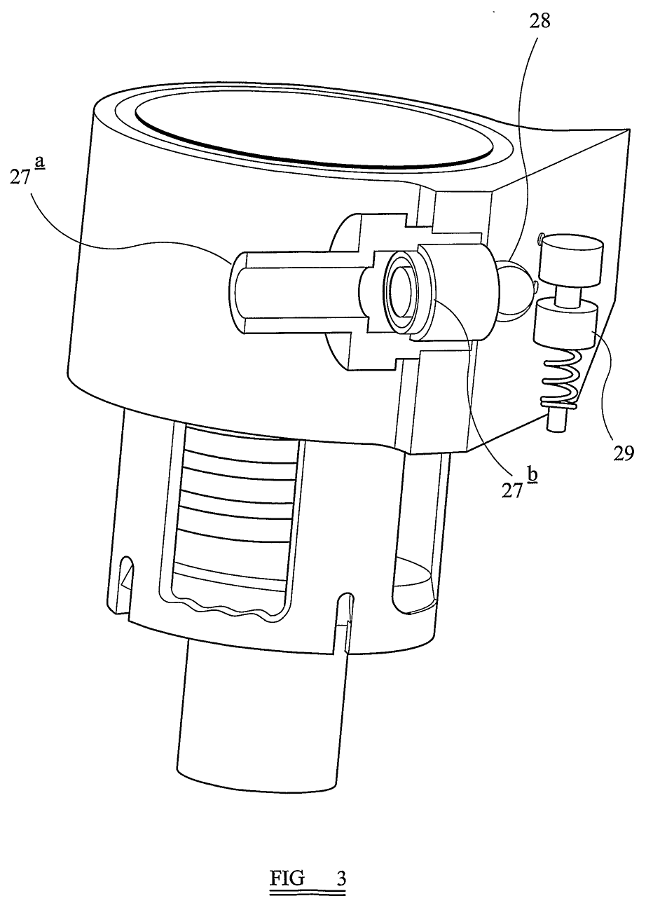

FIG. 2 is a part-sectional, similar view to FIG. 1 of an embodiment of a further valve of the invention, in a closed position, and with a liquid flushing arrangement thereof not shown,

FIG. 3 is a schematic perspective view of the valve of FIG. 1, at 90° thereto, showing details of a liquid flushing arrangement thereof,

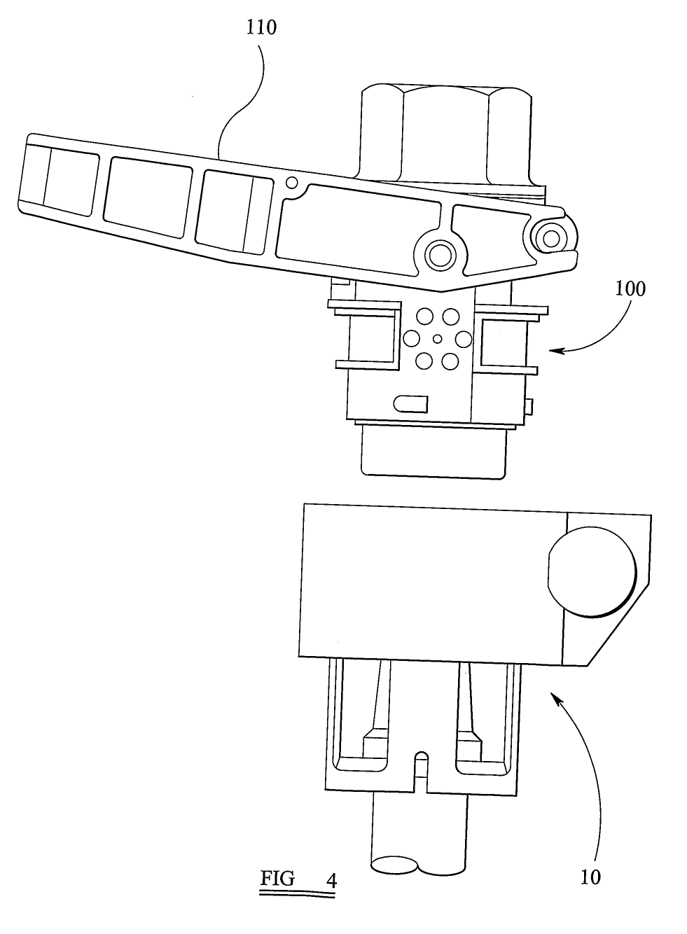

FIG. 4 is a side view showing a coupler in position for mating with the valve of FIG. 1,

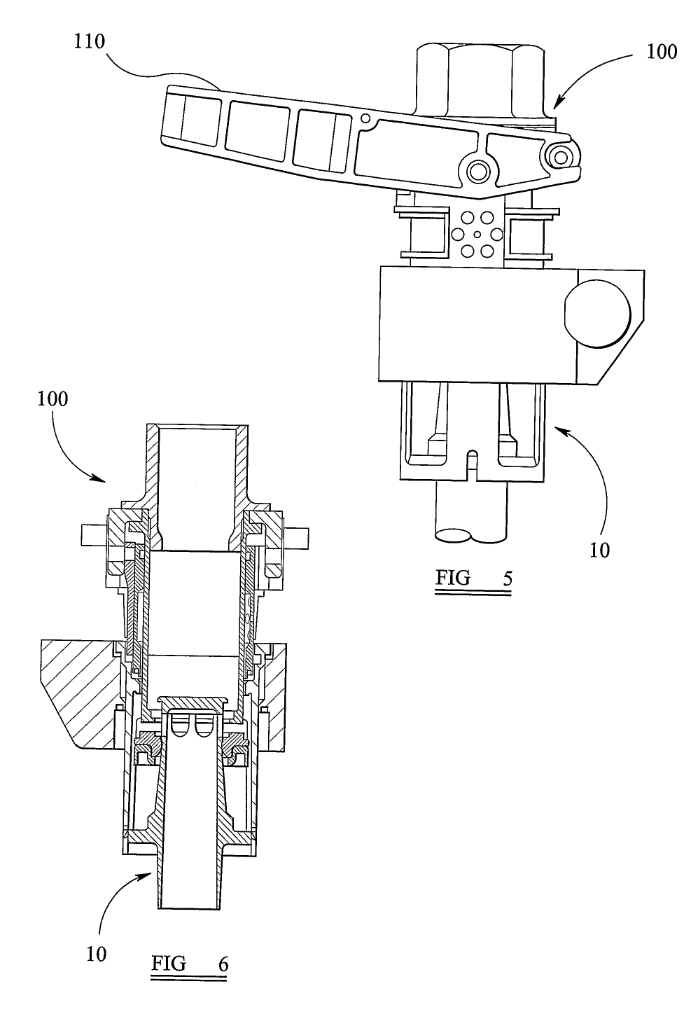

FIG. 5 shows a side view of the coupler engaged with the valve, and

FIG. 6 is a section showing the FIG. 5 engagement.

The valve of the invention shown in FIG. 1 is a development of a known valve which is used extensively in containers for a closed transfer system for agricultural chemicals. The valve of the invention shown in FIG. 1 incorporates such a known valve, and accordingly this will firstly be described.

This known valve 10 comprises an outer hollow cylindrical housing or cage 11. At its upper end the cage is provided with an exterior flange or collar 12, beneath which is provided an external screw-thread 13 for a short distance. At the interior of the upper end of the cage 11 there is provided a mating detail 14 for engagement by a known coupler 100 FIGS. 4 to 6. This coupler is of known form, being connected to some form of extraction device, and when engaged with the valve by way of the mating detail 14 the coupler can be activated, as will be described, by operation of a lever 10 on the coupler, and chemical sucked out of the container. FIG. 4 shows the coupler in position to engage with the valve.

Fixed centrally within the hollow cage 11 is a co-axial stem 15 which is generally of hollow circular section, but has its upper end closed by a top wall 16, this lying just below the bottom of the mating detail 14. The stem 15 is preferably secured in position in the outer cage 11 by an exterior annular collar 17 being secured at its outer periphery to the inside of the cage 11 as shown in FIG. 1. As can be seen from this Figure, the stem 15 extends downwardly below the extremity of the collar and also below the extremity of the cage 11, so that, in use, this stem extends down into the interior of the container to which the valve is fitted.

At its upper end, just below its top wall 16, the stem 15 is provided with a multiplicity of stem ports 18 arranged with a regular spacing around its periphery, these ports, in normal, known operation allowing access therethrough from the interior of the container, through the stem 15 and coupler, into a further container or tank associated with the coupler.

At the level of the top wall 16, there is provided a downwardly facing annular seat 19. This seat is integrally connected to the inner wall of the outer cage, and is spaced slightly inwardly therefrom. At a position slightly above this seat 19, the upper part of the top wall 16 of the stem 15 is provided with a downwardly facing annular shoulder 20, and as shown in FIG. 1, a seal 21, in a closed position of the valve, is arranged so that a corresponding annular seat 22 and an annular shoulder 23 thereof engage the seat 19 and shoulder 20 respectively, thereby to seal the space between the exterior of the stem 15 and the interior of the cage 11. At its periphery, the seal 21 engages, and thus seals against, the outer surface of the stem 15 and the inner surface of the cage 11. Accordingly with the seal in this closed position, the stem ports 18 are isolated from the upper part of the valve above the top wall 16 of the stem 15.

The under surface of the seal 21 is shaped to engage with an annular backing ring 24 which is urged into engagement with the seal 21 by a coiled compression spring 25, one end of which engages in an annular pocket at the underside of the ring 24, and the other end of which bears against the upper surface of the collar 17. Accordingly the spring 25 biases the closure means, formed by the seal 21 and backing ring 24, normally into its closed position shown in FIG. 1, in dashed lines. As stated, this is the closed position of the valve.

When the coupler is engaged in the mating detail, FIGS. 5 and 6, and its lever 110 activated, the closure means, namely the seal 21 and backing ring 24 are pushed slidingly downwardly about the exterior surface of the stem 15, against the bias of the spring 25, to the open position of the valve shown in full lines in FIG. 1, the seal 21 in this position having been moved to lie at or slightly below the lowest level of the stem ports 18 so as to open these ports to communication with the part of the valve above the top wall 16 of stem 15, so that there can now be flow through said ports. In other words in this position of the closure means, the valve is open.

Thus in use, with the valve open, chemicals in the container can be transferred therefrom, by some form of extraction device to which the coupler is connected, e.g. a pump or vacuum source, into a further container or tank.

A valve of the present invention comprises, in one embodiment, incorporating the valve 10 into a housing part 26 which is adapted to be engaged with the neck of a container by female threads 26a, in use, so that, for example, the container can be flushed with water without removing the coupler, and thereby ensure that the operator is not exposed to any harmful residues inside the container. The valve 10 can be made integral with the housing part 26, so that the integral composite valve can be considered to have a two-part housing, namely a first part for engagement with the neck of a container and a second part, formed by the valve 10, defining at least one inlet into the container when it is connected thereto, in use. Alternatively the valve 10 can be threadedly engaged with part 26 by means of the screw-thread 13.

As can be seen from FIG. 1, and in detail in FIG. 3, the structure of the valve 10 is substantially unaffected by its incorporation with the housing part 26, but it can be seen that this housing part is arranged to contain a water inlet connection with a non-return valve, preferably integral therewith, this inlet connection being denoted by the numeral 27a and the non-return valve by numeral 27b in FIG. 3. In the embodiment illustrated, the liquid flushing arrangement also includes an actuating plunger 28 and a sensing valve 29 which, in use, senses the internal pressure in the container.

As can be seen from FIG. 1, the liquid flushing arrangement is arranged in the housing part 26 so that the plunger 28 can extend into the space between the interior surface of the cage and the exterior surface of the stem 15. This plunger is spring loaded so as to extend into this space, when the valve is open, and open the liquid flushing arrangement, i.e. to allow liquid, for example water, to flow in through the water inlet connection 27. However it will be understood from FIG. 1 that when the closure means is in its normal position, i.e. with the valve 10 closed, the plunger 28 will close the water inlet connection 27 in that it cannot project into said space, as described above, in that it is prevented from doing so by its engagement against the outer side of the backing ring 24 which is at the level of the plunger 28 when the closure means is in its closed position shown in dashed lines in FIG. 1. Accordingly when the composite valve is closed, i.e. with the coupler connected but with the lever thereof not actuated, the plunger is held in its closed position thereby preventing flushing water entering through the connection 27.

However when the lever 110 of the coupler 100 is actuated so as to force down the closure means to the position shown in FIG. 1 in full, it will be understood that as the seal moves past the inwardly depressed plunger, the plunger will immediately be forced outwardly by its spring loading to the position in which it is shown in FIG. 1. In this position the stem ports 18 are in communication with the part of the valve above the level of said ports, and since the liquid flushing arrangement is now open, water supplied to the inlet connection 27 can flow to the stem ports 18, through the stem 15, and into the container. This condition prevails until the lever of the coupler is again activated to close the valve 10. When this occurs, the upwards movement of the closure means depresses the plunger against its spring bias thereby cutting-off the flow of water through the inlet connection 27.

Accordingly with the valve of the present invention water for flushing the container can be introduced into it without having to ‘open’ the container, i.e. to remove the valve 10 from it. Accordingly with the present invention there is no danger to the operator, and the resultant washings of the container can be sucked out via a closed system. Typically some form of extraction device, such as a pump or vacuum source, to which the coupler is connected, sucks the washings into a further container or mixing tank, i.e. the same destination as the original contents of the container.

In a preferred embodiment, for example as shown in FIG. 1, there can be a requirement for a valve to shut-off the water if the pressure in the container being flushed exceeds a certain level. This valve is necessary where the composite valve is used with a thin-walled blow-moulded container which is tested to a maximum internal pressure of 1 bar. If pressures within the container were to exceed this level, a hazardous situation could arise, and accordingly in this preferred embodiment a pressure-sensing valve shuts off the water supply when the pressure inside the container exceeds, for example, 0.7 bars.

FIG. 2 shows a valve of a further invention. This valve is similar to known valve 10 but is adapted for use where the headroom above the neck on a container is restricted. Like parts have been numbered with the same numerals as for the valve 10 shown in FIG. 1. However it can be seen that the upper part of the cage 11 is extended radially outwardly to provide a housing part 30. This is provided in its underside with a circular section recess 31, which has at its inner periphery 32 female threads 33 to suit the male threads on the exterior of the neck of the container to which the valve of FIG. 2 is connected. The housing part 30 has an annular recess 34 extending vertically therethrough, and slidably received in said recess 34 is a mating element 35 which in its upper end is provided with a mating detail 36 equivalent to the mating detail 14 shown in FIG. 1, so that this element 35 can be connected to a coupler, equivalent to coupler 100, in the same way as with the FIG. 1 embodiment, actuation of the lever of the coupler depressing the closure means of the valve of FIG. 2 as described above.

The distance between the upper and lower parts of the mating element 35 is greater than the height of the housing part 30, as shown in FIG. 2, so that the mating element 35 can be lifted from its FIG. 2 position where its top part rests on the upper surface of the housing part 30. Typically this upper part could be lifted by 6 mm. Accordingly the mating detail of the valve is retractable such that it is only pulled out from the top of the valve when needed and thereby reduces the headroom otherwise required.

Although not shown in FIG. 2, this valve with retractable mating element 35 could incorporate the liquid flushing arrangement described in relation to FIG. 1. In other words it could incorporate the flushing arrangement in its broadest sense, namely a liquid flushing arrangement which allows flushing liquid to flow through the valve when the closure means is in its open position and prevent such flow when the closure means is in its closed position. However the FIG. 2 valve is considered novel and inventive in its own right, i.e. without the flushing arrangement.

1. A valve comprising a housing having a first part for engagement with a neck of a container, a second part defining at least one inlet into the container, when the first part is engaged with the container, in use, spring loaded closure means normally being in a closed position preventing access, in use, to said at least one inlet, the closure means being movable, against said spring loading to an open position to allow such access, by a coupler affixed to said housing, in use, the valve being characterised by a liquid flushing arrangement for introducing flushing liquid into the container, in use, through a non-return valve, said liquid flushing arrangement allowing flushing liquid to flow through said at least one inlet when said closure means is in its open position and preventing flow of flushing liquid when said closure means is in its closed position.

2. A valve as claimed in claim 1, wherein the liquid flushing arrangement comprises a flushing liquid inlet connection at said first part of the housing.

3. A valve as claimed in claim 1, wherein the liquid flushing arrangement comprises a spring-loaded plunger which protrudes into the path of movement of the closure means.

4. A valve as claimed in claim 3, wherein when the closure means is in its closed position the plunger is engaged by the closure means to retain the plunger in a position where it shuts off liquid flow through the liquid flushing arrangement.

5. A valve as claimed in claim 3, wherein when the closure means is in its open position the plunger is in a released position, where it allows flushing liquid to flow through the liquid flushing arrangement and to said at least one inlet, into the container, in use.

6. A valve as claimed in claim 1, wherein the liquid flushing arrangement includes sensing means for sensing, in use, the internal pressure in the container.

7. A valve as claimed in claim 1, wherein the coupler can be affixed, in use, to said housing by way of a mating detail which is retractable relative to the remainder of the housing.

8. A valve as claimed in claim 1, wherein said first part of the housing is provided with female screw threads for engagement with said neck of the container.

9. A valve as claimed in claim 1, wherein said first part of the housing is integral with a cage within which said second housing part is fixed.

10. A valve as claimed in claim 1, wherein there is a screw-thread connection between said first part of the housing and a cage within said second housing part is fixed.

11. A valve comprising a housing for engagement with a neck of a container and defining at least one inlet into the container, when the first part is engaged with the container, in use, a spring loaded closure means normally in a closed position preventing access, in use, to said at least one inlet, the closure means being movable, against said spring loading to an open position to allow such access, by a coupler affixed to said housing, in use, and mating means for mating with said coupler so that it can be affixed to said housing, said mating means being provided by means which are retractable and extendable relative to said housing.

12. A valve as claimed in claim 11, wherein the means providing said mating means is retractable and extendable within an annular recess in said housing.

13. A valve as claimed in claim 11, wherein in its retracted state, part of said means bears on an outer surface of the housing, and in its retracted state, said part of said means is disposed clear of said outer surface of the housing.

14-15. (canceled)
